(19) United States
(12) Patent Application Publication
(10) Pub. No.: US 2018/0070568 A1
(43) Pub. Date: Mar. 15, 2018

(54) TOP WATER LURE BAIT

(71) Applicant: Donald J. Ciacchi, Middleburg Heights, OH (US)

(72) Inventor: Donald J. Ciacchi, Middleburg Heights, OH (US)

(21) Appl. No.: 15/410,835

(22) Filed: Jan. 20, 2017

Related U.S. Application Data
(60) Provisional application No. 62/281,456, filed on Jan. 21, 2016.

(51) Int. Cl. A01K 85/02; A01K 85/12; A01K 93/00

(52) U.S. Cl. CPC A01K 85/02; A01K 93/00; A01K 85/12

(57) ABSTRACT

A lure bait including an elongated body and at least one ventral hook. The elongated body includes a dorsal surface having a convex shape, a ventral surface opposite the dorsal surface having a concave shape, a distal end, and a proximal end. The proximal end includes an angled bill having a flat transverse surface extending from the dorsal surface to the ventral surface. The at least one ventral hook is connected to the ventral surface of the elongated body. The angled bill is angled such that when the elongated body is pulled from the proximal end along the surface of the water, the water exerts a force on the angled bill, thereby causing the distal end of the elongated body to rise relative to the proximal end and cause the proximal end to shield the at least one ventral hook from entanglements located in the water.

### RELATED APPLICATIONS

This application claims the benefit of Application No. 62/281,456 filed on Jan. 21, 2016, which is herein incorporated by reference in its entirety.

### TECHNICAL FIELD

The present disclosure relates generally to fishing products and more particularly to a top water lure bait.

### SUMMARY

This disclosure relates to a top floating bait used in fishing. The bait is made of a material such that it floats on the surface of water. For example, the bait may be made of wood, plastic, rubber, metal (e.g., aluminum), or any other suitable material.

According to one aspect, there is provided a lure bait configured to float on a surface of water. The lure bait including an elongated body an attachment structure and at least one ventral hook. The elongated body includes a dorsal surface having a convex shape, a ventral surface opposite the dorsal surface having a concave shape, a distal end, and a proximal end. The proximal end includes an angled bill having a flat transverse surface extending from the dorsal surface to the ventral surface. The attachment structure is located on the angled bill. The at least one ventral hook is connected to the ventral surface of the elongated body. The angled bill is angled such that when the elongated body is pulled from the proximal end along the surface of the water, the water exerts a force on the angled bill, thereby causing the distal end of the elongated body to rise relative to the proximal end and cause the proximal end to shield the at least one ventral hook from entanglements located in the water.

A number of features are described herein with respect to embodiments of the invention; it will be appreciated that features described with respect to a given embodiment also may be employed in connection with other embodiments.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a view of one side of the bait.

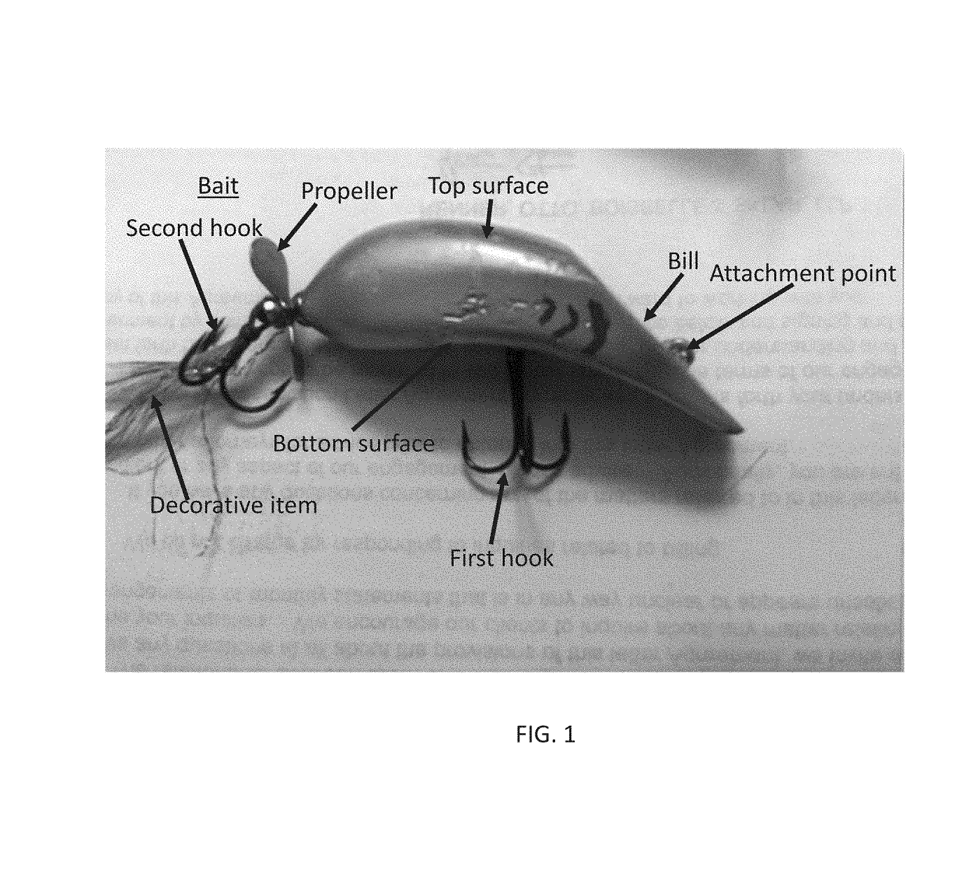

FIG. 2 is a view of the other side of the bait shown in FIG. 1.

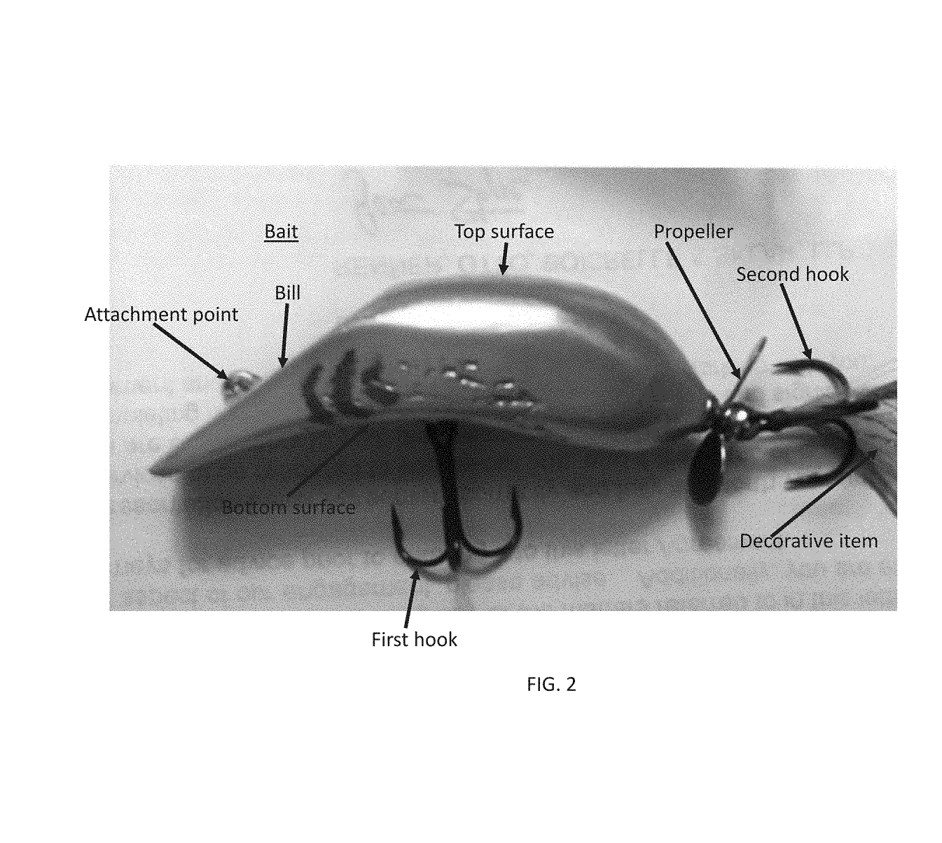

FIG. 3 is a perspective view of the bait.

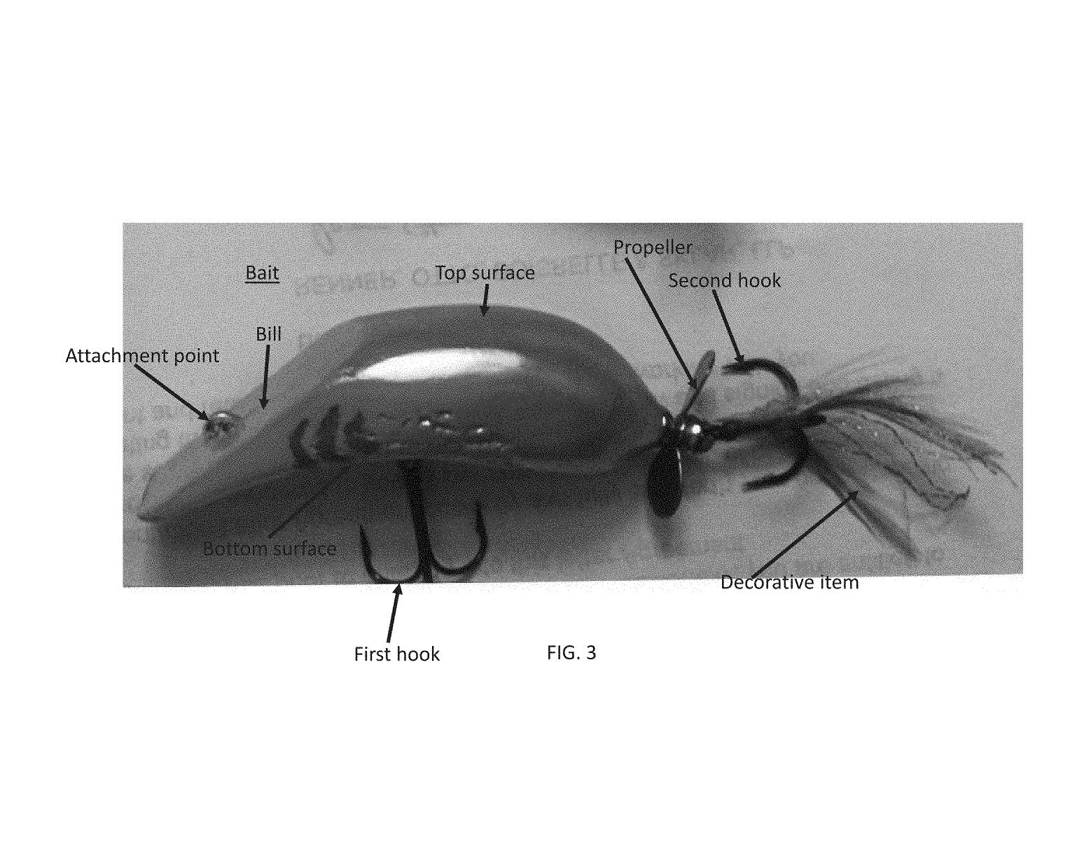

FIG. 4 is a view of the bottom surface of the bait.

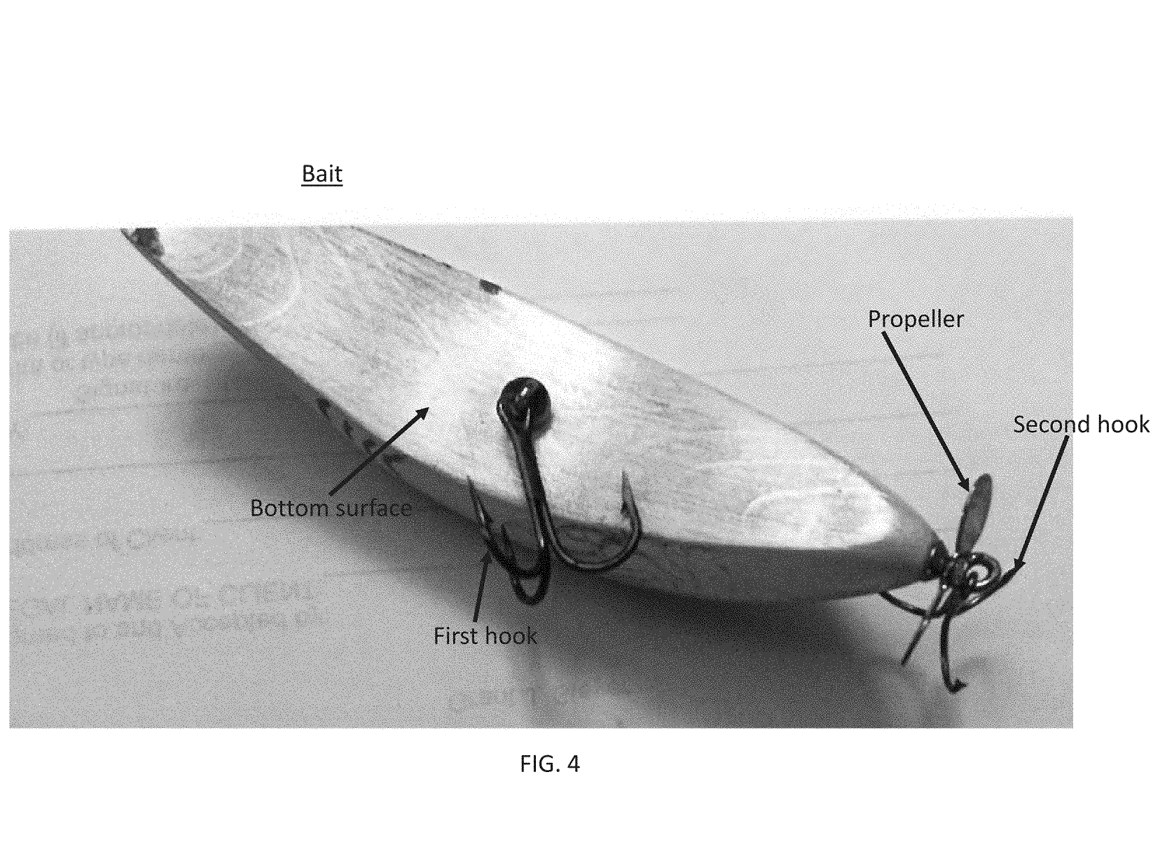

FIG. 5 is a side view of two baits of different sizes.

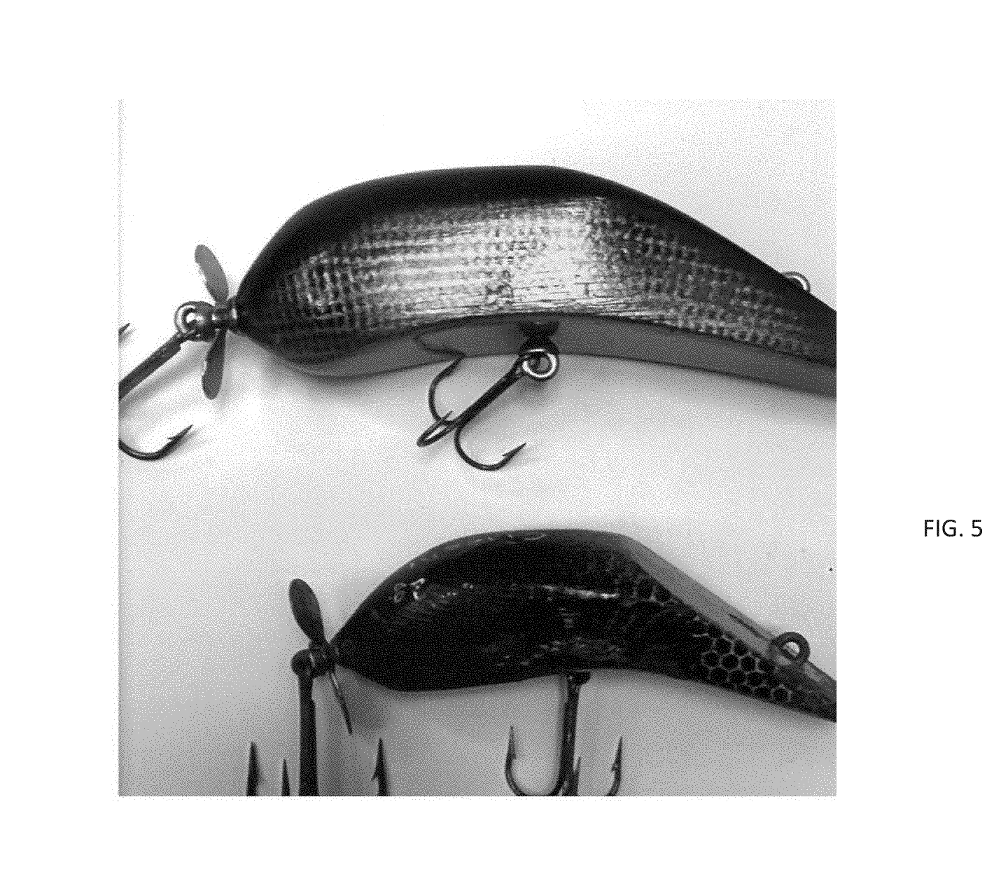

FIG. 6 is a perspective view of the dorsal surface of two baits of different sizes.

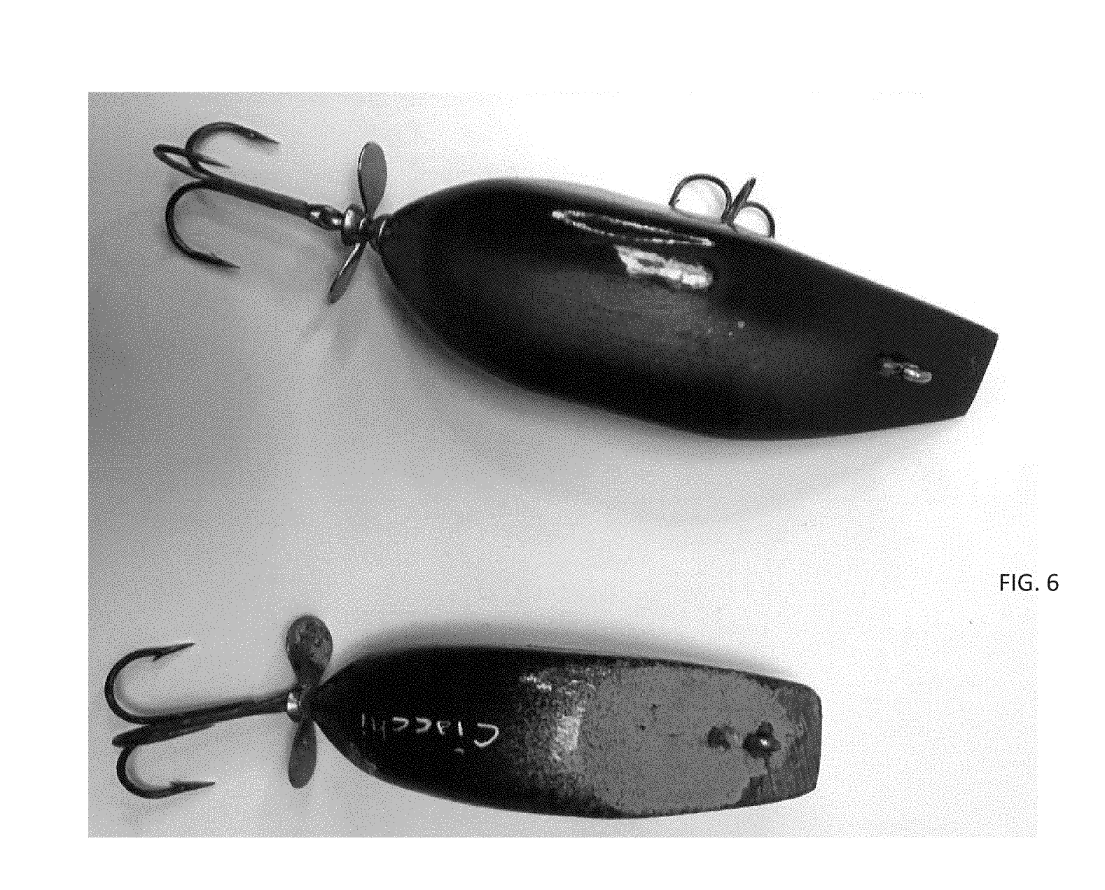

FIG. 7 is another perspective view of the dorsal surface of the two baits of FIG. 6.

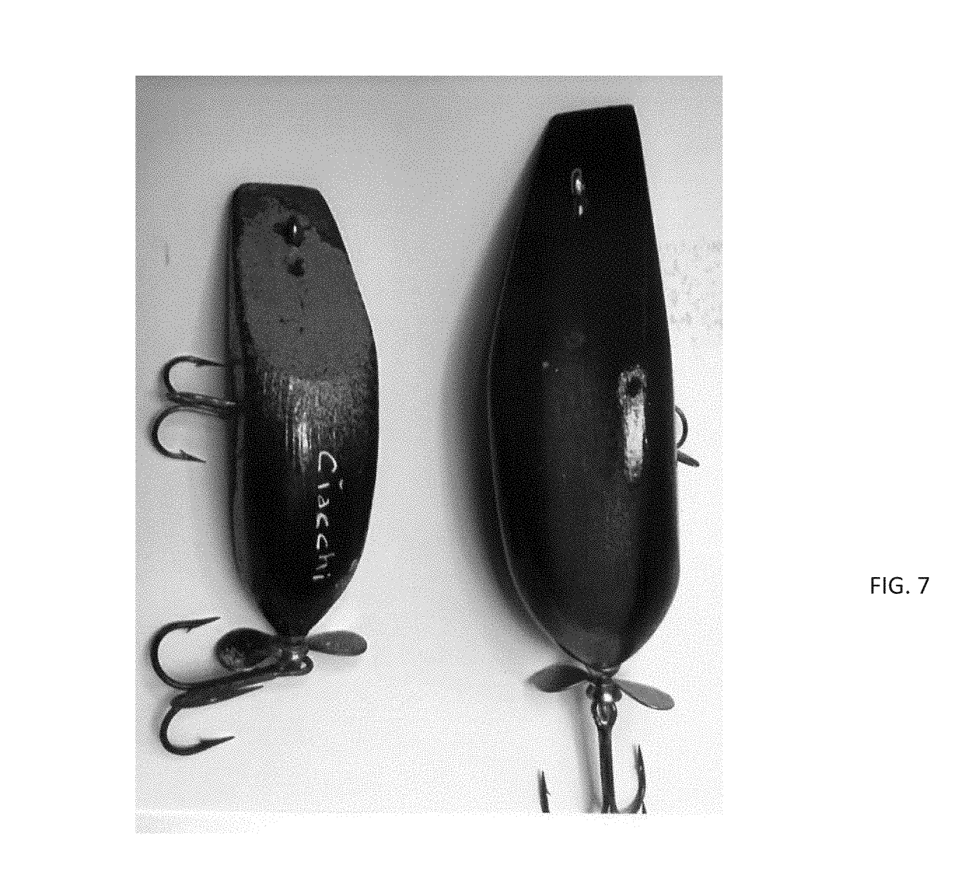

FIG. 8 is a view of the ventral surface of the two baits of FIG. 6.

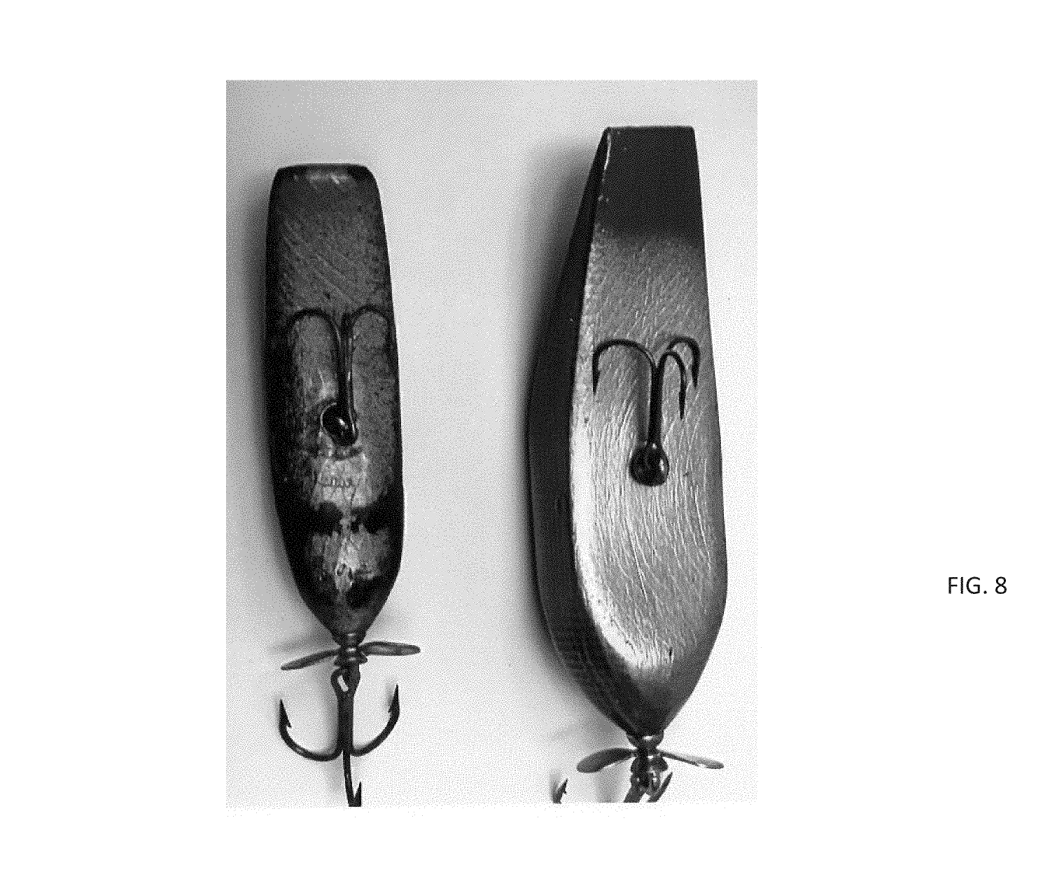

FIG. 9 is a perspective view of the side of the two baits of FIG. 6.

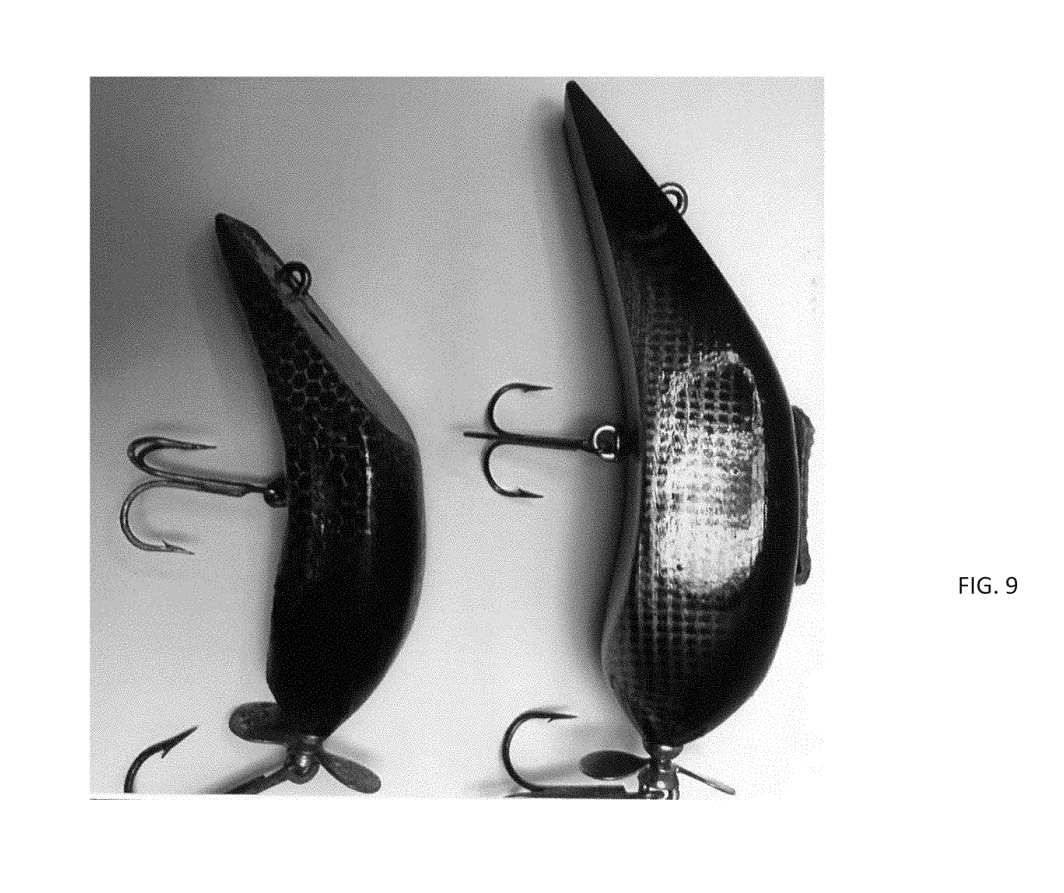

### DETAILED DESCRIPTION

As shown in the figures, the bait includes an elongated body having a dorsal (e.g., top) surface, a ventral (e.g., bottom) surface, a proximal end, a distal end opposite the proximal end. The dorsal surface has a convex shape. As will be understood by one of ordinary skill in the art, the dorsal surface having a convex shape may refer to the dorsal surface having a predominately convex shape or an entirely convex shape. The overall shape of the bait may resemble that of a banana. The proximal end may include an angled bill having a flat transverse surface extending from the dorsal surface to the ventral surface at an angle. As will be understood by one of ordinary skill in the art, the flat transverse surface may not be entirely flat, but instead the flat transverse surface may be predominately flat. The angled bill may extend for ⅓ to ½ of the length of the bait. The distal end of the dorsal surface may be predominately curved. The ventral surface has a concave shape. As will be understood by one of ordinary skill in the art, the ventral surface having a concave shape may refer to the ventral surface having a predominately concave shape or an entirely convex shape.

The angled bill includes an attachment structure for connecting a fishing line to the bait. The attachment structure may be located towards a center point of the angled bill. The angled bill is angled such that, as the bait is pulled forward by a line connected to the attachment structure, the distal end of the lure is raised up relative to the proximal end due to the force exerted by water on the angled bill. While the bait is being pulled forward, the distal end is raised sufficiently such that the ventral hooks attached to the ventral surface or the distal hooks attached to the distal end of the bait are raised above the proximal end of the bait. In this way, the ventral hooks are shielded by the bill as the bait travels through the water, preventing or reducing the chance of the ventral hooks becoming tangled in weeds, lily pads, and/or other obstacles.

The distal end of the bait may include a propeller and/or other decorative items. When pulled through the water, the propeller may be spun by the water. The spinning of the propeller may generate bubbles, which serves to attract fish. Other decorative items may be attached to the distal end of the bait, such as ribbon, string, frills, or any other suitable items designed to attract fish.

The bait is constructed such that reeling in of the bait under typical fishing conditions may result in the bait sinking to a maximum depth of 1.5 to 2.0 feet. The construction of the bait may refer to the shape of the bait (including the angle of the angled bill) and the buoyancy of the bait. The bait may sink due to force generated by water interacting with the angled bill of the bait.

The bait may include two sets of fishing hooks. The first set of fishing hooks may be attached to the center of the ventral surface of the bait. The second set of fishing hooks may be attached to or near to the propeller at the distal end of the bait.

When fishing the bait, the bait is cast into a body of water and pulled forward at varying intervals. Pulling forward (i.e., reeling in) the bait may cause the bait to wiggle in the water as well as cause the bait to become at least partially submerged due to the force exerted by passing water on the angled bill of the bait.

The bait may be of varying sizes. For example, depending on the type of fish one is fishing for, the bait may have a smaller or larger size. For example, the bait may be between two inches and six inches in length and 1 inch to 4 inches in width.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A lure bait configured to float on a surface of water, the lure bait comprising:
an elongated body including:
a dorsal surface having a convex shape;
a ventral surface opposite the dorsal surface, the ventral surface having a concave shape;
a distal end; and
a proximal end, including an angled bill having a flat transverse surface extending from the dorsal surface to the ventral surface;
an attachment structure on the angled bill; and
at least one ventral hook connected to the ventral surface of the elongated body;
wherein, the angled bill is angled such that when the elongated body is pulled from the proximal end along the surface of the water, the water exerts a force on the angled bill, thereby causing the distal end of the elongated body to rise relative to the proximal end and cause the proximal end to shield the at least one ventral hook from entanglements located in the water.

2. The lure bait of claim 1, further comprising a propeller connected to the distal end of the elongated body, wherein when the elongated body is pulled from the proximal end along the surface of the water, the water exerts a force on the propeller, thereby causing the propeller to spin.

3. The lure bait of claim 2, further comprising at least one distal hook connected to the distal end.

4. The lure bait of claim 1, further comprising at least one decorative item connected to the distal end.

5. The lure bait of claim 1, wherein the elongated body has a length in the range of 2-6 inches and a width in the range of 1-4 inches.

6. The lure bait of claim 1, wherein when the elongated body is pulled from the proximal end along the surface of the water, the water exerts a force on the angled bill that causes the lure bait to become submerged below the surface of the water.
